(19) United States
(12) Patent Application Publication
(10) Pub. No.: US 2026/0112121 A1
(43) Pub. Date: Apr. 23, 2026

(54) INFORMATION PROCESSING APPARATUS, INFORMATION PROCESSING METHOD, AND PROGRAM

(71) Applicant: Sony Group Corporation, Tokyo (JP)

(72) Inventors: Kouichi UCHIMURA, Kanagawa (JP); Naoki SHINMEN, Tokyo (JP)

(73) Assignee: Sony Group Corporation, Tokyo (JP)

(21) Appl. No.: 19/117,966

(22) PCT Filed: Sep. 21, 2023
(86) PCT No.: PCT/JP2023/034267

§ 371 Date: Apr. 3, 2025

(30) Foreign Application Priority Data
Mar. 31, 2023 (JP) 2023-057950

(51) Int. Cl. G06T 19/00

(52) U.S. Cl. CPC G06T 19/00; G06T 2200/24

(57) ABSTRACT

An information processing apparatus includes circuitry that determines, based on virtual space attribute information associated with a virtual space of a plurality of different virtual spaces and first content management information associated with first content, whether or not the first content is permitted to be used in the virtual space. The circuitry further controls placement, when the first content is permitted to be used in the virtual space, of the first content in the virtual space based on first content attribute information of the first content and second content attribute information associated with second content already placed in the virtual space.

### TECHNICAL FIELD

The present disclosure relates to an information processing apparatus, an information processing method, and a program.

### BACKGROUND ART

Recently, a technology is known which provides, via a virtual space server, a virtual space where various virtual objects, such as 3D models or 2D images, are to be placed. A user can experience the virtual space via various forms of user terminals such as a smartphone, an HMD (head-mounted display), and a PC. In the virtual space, a character (so-called avatar) that is associated with the user and can be operated by the user may also be placed. In the virtual space, the user can also interact with another user via his own avatar.

For example, PTL I discloses a technology in which, when a distributer performs live streaming using an avatar that is synchronized his movement, behaviors (such as comments allowed or not, NG words, or filming action) of viewers who watch the live streaming are restricted on the basis of additional information added to the avatar.

### CITATION LIST

### Patent Literature

PTL 1: JP 2020-17950A

### SUMMARY

### Technical Problem

In recent years, a large number of virtual spaces have been provided, and it is assumed that various contents, such as characters or items, are brought into various virtual spaces by users of the contents, but it is desirable that the contents are used in the virtual spaces on the basis of intentions of creators of the contents.

Accordingly, the present disclosure proposes an information processing apparatus, an information processing method, and a program that allow handling of a content in a virtual space to be controlled on the basis of attribute information of the content.

### Solution to Problem

According to the present disclosure, there is provided an information processing apparatus including circuitry configured to determine, based on virtual space attribute information associated with a virtual space of a plurality of different virtual spaces and first content management information associated with first content, whether or not the first content is permitted to be used in the virtual space, and control placement, when the first content is permitted to be used in the virtual space, of the first content in the virtual space based on first content attribute information of the first content and second content attribute information associated with second content already placed in the virtual space.

Additionally, according to the present disclosure, there is provided an information processing method including determining, based on virtual space attribute information associated with a virtual space of a plurality of different virtual spaces and first content management information associated with first content, whether or not the first content is permitted to be used in the virtual space, and controlling placement, when the first content is permitted to be used in the virtual space, of the first content in the virtual space based on first content attribute information of the first content and second content attribute information associated with second content already placed in the virtual space.

Still additionally, according to the present disclosure, there is provided a non-transitory computer-readable storage medium having embodied thereon a program, which when executed by a computer causes the computer to execute a method, the method includes determining, based on virtual space attribute information associated with a virtual space of a plurality of different virtual spaces and first content management information associated with first content, whether or not the first content is permitted to be used in the virtual space, and controlling placement, when the first content is permitted to be used in the virtual space, of the first content in the virtual space based on first content attribute in-formation of the first content and second content attribute information associated with second content already placed in the virtual space.

### BRIEF DESCRIPTION OF DRAWINGS

FIG. 1 is a diagram illustrating an overall configuration of an information processing system 1 according to an embodiment of the present disclosure.

FIG. 2 is a block diagram illustrating an example of a configuration of a management organization server 20 according to the present embodiment.

FIG. 3 is a block diagram illustrating an example of a configuration of a metaverse server 30 according to the present embodiment.

FIG. 4 is a flow chart illustrating an example of a flow of object usability determination processing according to the present embodiment.

FIG. 5 is a flow chart illustrating an example of object placeability determination processing according to the present embodiment.

FIG. 6 is a diagram illustrating an example of respective determination areas of a target object O1, a map M1, and one or more placed objects O2 and O3 according to the present embodiment.

FIG. 7 is a diagram illustrating area determination when there is a shielding object according to the present embodiment.

FIG. 8 is a flow chart illustrating another example of a flow of the object placeability determination processing according to the present embodiment.

### DESCRIPTION OF EMBODIMENTS

Referring to the accompanying drawings, a detailed description will be given below of a preferred embodiment of the present disclosure. Note that, in the present description and the drawings, components having substantially the same functional configurations are denoted by the same reference signs to omit a repetitive description thereof.

It is assumed that the description will be given in the following order:
1. Configuration
1-1. System Configuration
1-2. Configuration of Management Organization Server 20
1-3. Configuration of Metaverse Server 30
2. Operation Processing
2-1. Object Usability Determination Processing
2-2. Object Placeability Determination Processing
2-3. Object Placeability Determination Processing-Placement by Player
3. Supplement

### 1. Configuration

Using the drawings, a specific description will be given of an information processing system according to the embodiment of the present disclosure.

### <<1-1. System Configuration>>

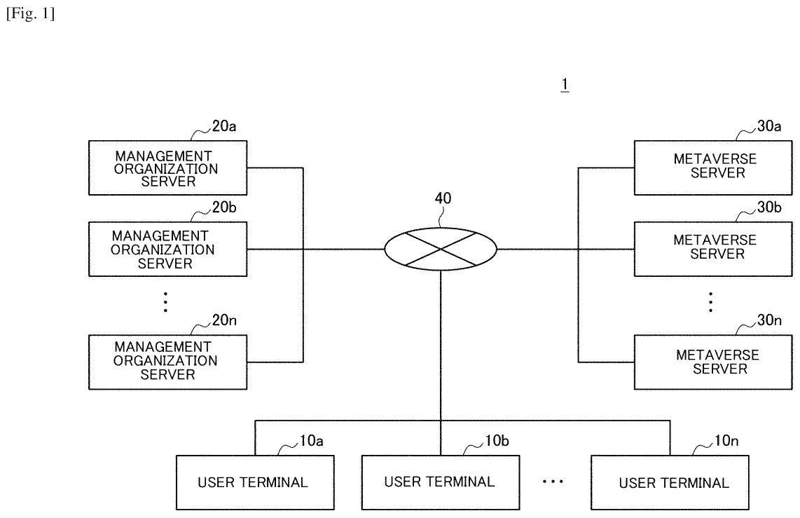

FIG. 1 is a diagram illustrating an overall configuration of an information processing system 1 according to the embodiment of the present disclosure. The information processing system 1 according to the present embodiment includes one or more management organization servers 20 (20a . . . 20n), one or more metaverse servers 30 (30a . . . 30n) (an example of an information processing apparatus), and one or more user terminals 10 (10a . . . 10n) to be used by individual users. The management organization servers 20, the metaverse servers 30, and the user terminals 10 can perform data transmission/reception via a network 40.

In the present system, it is assumed that each of creators who have created various objects (an example of contents), such as characters or items, belongs to a management organization that manages the objects. The creators may also belong to a plurality of the management organizations. The creator can register the created object in the management organization server 20 of the management organization to which he belongs and leave the management of the object to the management organization. The creator can also be referred to as a copyright holder. The creator is not limited to a natural person (individual), and may also be a corporate person. Alternatively, the creator may also be a creation group including a plurality of persons. The creator is not limited to a professional creator (creating entrepreneur), and may also be an amateur creator (such as a general consumer or a metaverse participant (such as a player)).

The management organization server 20 has a management organization ID for self identification. The management organization server 20 also issues creator IDs for creator identification to belonging creators. The management organization server 20 can also issue object IDs for object identification to registered objects.

The metaverse server 30 builds a metaverse (virtual space) and appropriately provides information required to draw a metaverse to the user terminals 10 via the network 40. The metaverse may also be built on the basis of a game engine that allows videos and sounds to be interactively presented. In the plurality of metaverse servers 30a to 30n, metaverses different from each other are built. The present embodiment assumes a state where the plurality of different metaverses, i.e., a so-called multiverse is provided. The plurality of metaverse servers 30 may be physical servers separated from each other, or may also be separate virtual servers operating in one physical server.

Each of the metaverses can be operated by a PF (platform) operator. In the present embodiment, by way of example, it is assumed that one metaverse is provided by the one metaverse server 30. The individual metaverses may be operated by PF operators different from each other, or the plurality of metaverses may also be operated by one PF operator. The PF operator is not limited to a natural person (individual), and may also be a corporate person. Alternatively, the PF operator may also be a PF operating group including a plurality of persons.

The PF operator sets one or more maps in the metaverse, and places various objects (such as characters, items, or buildings) in the maps. Each of the maps is a virtual space region used as the metaverse, and map coordinates can be set thereto. The PF operator assumes a scene and a theme of the map, and places the various items, buildings, and the like in the map. The map and the various objects such as the characters, items, and buildings may be prepared by the PF operator by himself, or may also be purchased from shops, acquired by outsourcing, or borrowed from another metaverse. The objects borrowed from another metaverse may assumedly include an object created by a general participant in the metaverse. When the PF operator uses an object not created by himself in the metaverse of his own, the PF operator becomes a user of the object. Note that a person who actually places the maps, the characters, and the like in the metaverse is not limited to the PF operator, and a case where a creator (such as a VR creator) entrusted with production of the metaverse by the PF operator actually performs the placement may also be assumed but, for the sake of description, it is assumed in the present embodiment that the PF operator is a producer of the metaverse.

When management of the objects to be used in the metaverse is performed by the management organization, by way of example, it is assumed that the PF operator who is the user of the objects also belongs to (is registered in) the management organization. The management organization server 20 issues a user ID for identifying a user (who is the PF operator herein). The PF operator may also belong to the plurality of management organizations. Alternatively, the PF operator himself may also be the management organization, i.e., a management authority.

As described above, the management organization server 20 has the function of issuing the management organization IDs, the creator (right holder) IDs, the object IDs, and the user IDs and, to each of the objects managed by the management organization server 20, the management organization ID, the creator (right holder) ID, the object ID, and the user ID are given as management information.

A user terminal 10 is an information processing terminal to be used by the user. The user terminal 10 is implemented by, e.g., a smartphone, a tablet terminal, a PC (personal computer), an HMD (Head mounted Display) covering an entire field of view, an eyeglass-type display device, a portable or stationary gaming machine, a projector, or the like. The user terminal 10 may be used when the PF operator builds the metaverse on the metaverse server 30 or may also be used by a participant who participates in the built metaverse. It is assumed that the participant who participates in the metaverse purchases an avatar which is a character to be used as his alter ego in the metaverse from an object sale shop or customizes and acquires the avatar by using an avatar production tool provided for a fee or free of charge. In this case, it can be said that the participant who participates in the metaverse is also the user of the object.

In recent years, a large number of metaverses (virtual spaces) have been provided, and it is assumed that various objects (contents), such as characters or items, are brought into various metaverses by users of the objects (PF operators of the metaverses or participants in the metaverses). However, it is undesirable that the objects are used in an unpreferable situation against intentions of creators of the objects or the like in the virtual spaces, and it is desirable that the objects are used on the basis of the intentions of the creators.

Accordingly, in the embodiment of the present disclosure, it is possible to control handling of the contents in the virtual spaces based on attribute information of the objects.

The description has been given heretofore of an outline of the information processing system 1 according to the embodiment of the present disclosure. Note that the system configuration illustrated in FIG. 1 is an example, and the present disclosure is not limited thereto.

Subsequently, a description will be given of a specific configuration of each of the devices included in the information processing system 1 according to the present embodiment with reference to the drawings.

### <<1-2. Configuration of Management Organization Server 20>>

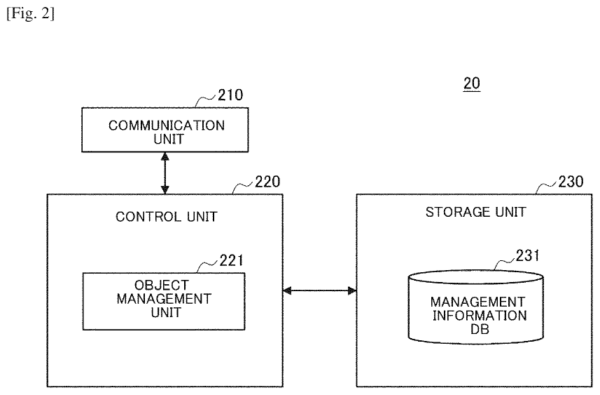

FIG. 2 is a block diagram illustrating an example of a configuration of the management organization server 20 according to the present embodiment. As illustrated in FIG. 2, the management organization server 20 includes a communication unit 210, a control unit 220, and a storage unit 230.

### (Communication Unit 210)

The communication unit 210 has a transmitter that transmits data to an external device and a receiver that receives data from the external device. The communication unit 210 according to the present embodiment may also use, e.g., a wired or wireless LAN (Local Area Network), Wi-Fi (registered trademark), Bluetooth (registered trademark), a mobile communication network (LTE (Long Term Evolution), 4G (4th generation mobile communication system), 5G (5th generation mobile communication system)), or the like to be communicatively connected to the external device or the Internet.

### (Control Unit 220)

The control unit 220 functions as an arithmetic processing device and a control device to control general operation in the management organization server 20 according to various programs. The control unit 220 is implemented by an electronic circuit such as, e.g., a CPU (Central Processing Unit) or a microprocessor. The control unit 220 may also include a ROM (Read Only Memory) that stores programs, arithmetic parameters, and the like to be used and a RAM (Random Access Memory) that temporarily stores accordingly varying parameters or the like.

The control unit 220 functions also as an object management unit 221. The object management unit 221 receives registration of an object from the creator belonging to the management organization, and manages the object by using the various IDs as the management information. For example, the object management unit 221 issues the management organization ID, the creator ID, and the object ID in response to an object registration application from the creator belonging to the management organization.

When a user of the object is generated through purchasing of the object or the like, the object management unit 221 further issues the user ID. In a case where the user is determined at the time of object registration, such as when the creator creates the object in response to a request from the PF operator, the object management unit 221 issues the management organization ID, the creator ID, the object ID, and the user ID in response to the object registration application from the creator. In addition, a case is also assumed where the object generated by a metaverse participant (player) in the metaverse is registered in the management organization server 20 from the user terminal 10. In this case also, the user is determined (to be the player) at the time of the object registration, and the object management unit 221 issues the management organization ID, the creator ID, the object ID, and the user ID. Note that the creator indicated by such a creator ID may be a player or may also be a creator of a tool or a material used by the player when generating the object in the metaverse.

The object management unit 221 associates the management organization ID, the creator (right holder) ID, the object ID, and the user ID with each other and stores the associated IDs as the management information in a management information DB 231.

It is also assumed that the PF operator possesses one or a plurality of metaverses (worlds) and uses an object therein, but in which metaverse the object is usable can be determined in advance by the creator. The creator can prevent use of his own object in a metaverse with a world view against his intention by specifying the metaverse in which the object is usable. It is assumed that the creator freely specifies, for the created object, a metaverse in which the object is usable or, when the object is created on commission from the PF operator, the creator specifies one or a plurality of metaverses of the pre-agreed PF operator. The object management unit 221 can issue the metaverse ID for identifying the metaverse (world), cause the metaverse ID to be included in the object management information, and store the object management information in the management information DB 231. Note that, as the object management information, at least either of the user ID and the metaverse ID may also be registered. When only the user ID is registered, a state where use in the one or plurality of metaverses possessed by the PF operator identified by the user ID is permitted is recognized.

The creator can not only specify, for his own object managed by the management organization server 20, the metaverse in which the object is usable, but also set various attributes of the object. As attributes to be generally given, an example in, e.g., Table 1 below can be listed. Table 1 below shows the example of the attributes in an existing format.

TABLE 1

| | |
|---|---|
| V R B | PERMISSION FOR VIOLENT EXPRESSION |
| | PERMISSION FOR SEXUAL EXPRESSION |
| | PERMISSION FOR COMMERCIAL USE |
| g I T F | c o p y r i g h t |
| | v e r s i o n |
| | m i n v e r s i o n |

In the present embodiment, it is possible to further set an extended attribute such as a prohibition attribute or a permission attribute to a placed object to be placed adjacent to the object. By setting such an extended attribute to the object, it is possible to avoid use of the object in a situation against the intention. The extended attribute can be set by the creator. Details of the extended attribute will be described later.

### (Storage Unit 230)

The storage unit 230 is implemented by a ROM that stores programs, arithmetic parameters, and the like to be used in processing by the control unit 220 and a RAM that temporarily stores accordingly varying parameters or the like.

The storage unit 230 also has the management information DB (database) 231 that stores the object management information. In the management information DB 231, such management information as shown in, e.g., Table 2 below can be stored.

TABLE 2

| | | MANAGEMENT | | | ATTRIBUTE |
|---|---|---|---|---|---|
| OBJECT ID | CREATOR ID | ORGANIZATION ID | USER ID | METAVERSE ID | INFORMATION |
| AAA1 | BBB1 | CCC1 | DDD1 | EEE1 | Date1 |
| AAA2 | BBB2 | CCC2 | DDD2 | EEE2 | Date2 |
| . . . | . . . | . . . | . . . | . . . | . . . |

Note that each of the objects and in which metaverse the object is usable may also be identified by a combination of the different IDs. For example, the object may be identified by a combination of the management organization ID, the creator ID, and the object ID, while in which metaverse the object is usable may be identified by a combination of the management organization ID, the user ID, and the metaverse ID. In this case, a list of the objects registered by, e.g., a creator B1 (creator ID: BBB1) is shown as in Table 3 below. Note that there is also a case where use of one object by one or a plurality of users or in one or a plurality of metaverses is permitted.

TABLE 3

| OBJECT | USE PERMISSION | |
|---|---|---|
| (MANAGEMENT ORGANIZATION ID, | (MANAGEMENT ORGANIZATION ID, | ATTRIBUTE |
| CREATOR ID, OBJECT ID) | USER ID, METAVERSE ID) | INFORMATION |
| CCC1, BBB1, AAA1 | CCC1, DDD1, EEE1 · EEE2 | Date1 |
| CCC1, BBB1, AAA2 | CCC1, DDD1, EEE1 | Date2 |
| CCC1, BBB1, AAA3 | CCC1, DDD3, EEE30 | Date3 |
| . . . | . . . | . . . |

According to Table 3 above, it can be seen that, in, e.g., a first row, as metaverses in which a given object (MANAGEMENT ORGANIZATION ID: CCC1, CREATOR ID: BBB1, METAVERSE ID: AAA1) of the creator B1 (CREATOR ID: BBB1) is usable, two metaverses which are the metaverse specified by META VERSE ID: EEE1 possessed by a user D1 having USER ID: DDD1 and the metaverse specified by METAVERSE ID: EEE2 are specified.

Meanwhile, a list of the objects with respect to which, e.g., the user D1 (USER ID: DDD1) has obtained a use permission is shown as in Table 4 below.

TABLE 4

| OBJECT | USE PERMISSION | |
|---|---|---|
| (MANAGEMENT ORGANIZATION ID, | (MANAGEMENT ORGANIZATION ID, | ATTRIBUTE |
| CREATOR ID, OBJECT ID) | USER ID, AND METAVERSE ID) | INFORMATION |
| CCC1, BBB1, AAA1 | CCC1, DDD1, EEE1 · EEE2 | Date1 |
| CCC1, BBB2, AAA20 | CCC1, DDD1, EEE2 | Date20 |
| CCC1, BBB3, AAA31 | CCC1, DDD1, EEE1 · EEE3 | Date31 |
| . . . | . . . | . . . |

According to Table 4 above, it can be seen that, in, e.g., a first row, a user D1 (USER ID: DDD1) has obtained a permission to use a given object (MANAGEMENT ORGANIZATION ID: CCC1, CREATOR ID: BBB1, METAVERSE ID: AAA1) in two metaverses which are the metaverse possessed by the user D1 and specified by METAVERSE ID: EEE1 and the metaverse specified by META VERSE ID: EEE2.

Subsequently, a description will be given of a specific example of the attribute information included in the management information of each of the objects.

As described above, the attribute information can include not only the attributes in the existing format, but also the extended attribute. An example of extended attribute items in the present embodiment is shown in Table 5 below. Note that the objects have types such as a character, an avatar (character that can be operated by a metaverse participant as his alter ego), an item, and a map, and there are attribute items common to all the object types and specific attribute items.

TABLE 5

| OBJECT TYPE | ATTRIBUTE ITEM |
|---|---|
| ALL | SIZE |
| (CHARACTER, AVATAR, | WEIGHT |
| ITEM, MAP) | ADDRESS OF OBJECT OWNER IN REAL WORLD |
| | REGISTRATION SERVER OPERATOR (PF OPERATOR) |
| | REGISTRATION METAVERSE |
| | ADDRESS IN FICTION SETTING |
| | TARGET AGE |
| | UGC (USER GENERATED CONTENT) OR NOT |
| | WORLD VIEW |
| | DETERMINATION AREA |
| | HOLDER OF AUTHORITY TO CHANGE VARIOUS SETTINGS |
| CHARACTER, AVATAR | REAL AGE OF PLAYER |
| | AGE IN CHARACTER SETTING |
| | GENDER |
| | RACE/CATEGORY |
| | OCCUPATION |
| | LICENSE HELD IN VIRTUAL SPACE |
| ITEM | PRIMARY CREATION, SECONDARY CREATION |
| | (INFORMATION ON PRIMARY CREATOR IN CASE OF SECONDARY CREATION) |
| | CREATOR |
| | OWNER |
| MAP (SCENE) | CAPACITY FOR PERSONS |

In Table 5 above, “REGISTRATION SERVER OPERATOR” is a PF operator who operates the metaverse server 30 in which the objects are registered (brought). Meanwhile, “REGISTRATION METAVERSE” is a metaverse (referred to also as a world) in which the objects are registered (brought).

In Table 5 above, “WORLD VIEW” is a world view of the object, and a genre such as, e.g., fantasy or near future is assumed.

In Table 5 above, “DETERMINATION AREA” is information indicating a range of placeability determination based on an adjacent placement prohibition attribute or permission attribute described later, which is performed when the object is to be placed in the metaverse.

In Table 5 above, “HOLDER OF AUTHORITY TO CHANGE VARIOUS SETTINGS” is information indicating a holder of an authority to change various settings such as the target age, the world view, the determination area, a registered user, the registration metaverse, the capacity for persons, a value of the adjacent placement prohibition attribute or permission attribute described later, or a prohibition level described later. As a person holding such an authority, e.g., the creator of the object is assumed and, to a value of the attribute item, the creator ID corresponds. It is also assumed that the authority has been delegated from the creator to the PF operator who is the user of the object and, in that case, to a value of the attribute item, the ID (user ID) of the PF operator is set.

In Table 5 above, as the “OWNER”, e.g., a player who purchased and is using the item is assumed.

The attribute information described heretofore may manually be input by the creator or may also be automatically generated by the management organization server 20 or the metaverse server 30 by using a conditional expression or artificial intelligence. It can be considered that, when the object is registered in the management organization server 20, the management organization server 20 automatically generates the attribute information as appropriate and gives the attribute information thereto. It can also be considered that, when the object is registered (brought) in the metaverse server 30, the metaverse server 30 automatically generates the attribute information as appropriate and gives the attribute information thereto. It may also be possible that the attribute information is not only stored as the management information in the management information DB 231, but also embedded in the object. For example, it is assumed that the creator embeds the attribute information in the object without interposition of the management organization. It may also be possible that the attribute information is not stored as the management information in the management information DB 231, but is only embedded in the object. Note that the attribute information may also be provided with measures for confidentiality or anti-tampering.

Each of the attribute items shown in Table 5 above can include not only data indicating the attribute of the object, but also data on the adjacent placement prohibition and permission attributes. The adjacent placement prohibition and permission attributes are attributes of another object that prohibit and permit, when an object is to be placed in the metaverse (map thereof), placement of the other object adjacent to the object. Each of the attribute items may also include at least either of the prohibition attribute and the permission attribute.

An example of data that can be included in each of the attribute items shown in Table 5 above is shown in Table 6 below.

TABLE 6

| DATA TYPE | CONTENT OF DATA |
|---|---|
| ATTRIBUTE OF OBJECT | VALUE (NAME) |
| ADJACENT PLACEMENT | LIST OF VALUES OR DETERMINATION EXPRESSIONS |
| PROHIBITION ATTRIBUTE | MANAGEMENT LEVEL |
| ADJACENT PLACEMENT | LIST OF VALUES OR DETERMINATION EXPRESSIONS |
| PERMISSION ATTRIBUTE | MANAGEMENT LEVEL |

For example, as an example of the value of the attribute of the object in “ATTRIBUTE ITEM: SIZE” of the object. “1.6 m”, “0.2 mx0.6 mx1.6 m”, or the like can be listed. In addition, as an example of the adjacent placement permission attribute of the same attribute item, e.g., “<2 m” (i.e., permission of placement of the other object less than 2 m adjacent to the object) can be listed.

Additionally, as the adjacent placement prohibition attribute in “ATTRIBUTE ITEM: WORLD VIEW” of the object, “+ATTRIBUTE OF OBJECT” (prohibition of placement of the other object having a world view different from the world view of the object adjacent to the object) can be listed.

Still additionally, as an example of the value of the attribute of the object in “ATTRIBUTE ITEM: REAL AGE OF PLAYER” of the object (e.g., avatar), “25 YEARS OLD” (real age of the player of the object) or the like can be listed. Yet additionally, as an example of the adjacent placement permission attribute of the same attribute item, “≥16 YEARS OLD” (i.e., permission of placement of another object (e.g., avatar) of a player having a real age over sixteen years old adjacent to the object) can be listed. Still additionally, as an example of the adjacent placement prohibition attribute of the same attribute item, “<16 YEARS OLD” (i.e., prohibition of placement of another object (e.g., avatar) of a player having a real age under sixteen years old adjacent to the object) can be listed.

The determination expression may also be an expression of, e.g., a result of a value magnitude comparison, whether or not there is a match to a logical expression, or the like, which is written in a program that returns a true/false binary value or the like.

In Table 6 above, “MANAGEMENT LEVEL” is a prohibition or permission level, and a criterion as shown in, e.g., Table 7 below can be considered.

TABLE 7

| MANAGEMENT LEVEL | CRITERION |
|---|---|
| 0 | NON-MANAGEMENT TARGET |
| 1 | UNRECOMMENDED |
| 2 | UNPERMITTED BY CREATOR |
| 3 | UNPERMITTED BY PF OPERATOR |
| 4 | LEGALLY UNPERMITTED |

In Table 7 above. “MANAGEMENT LEVEL 0: NON-MANAGEMENT TARGET” indicates that the permission attribute or the prohibition attribute has been set, but there is no need to perform subsequent management. For example, even when, e.g., another object does not correspond to the permission attribute or corresponds to the prohibition attribute, the user (PF operator or player) can perform the placement.

Additionally, in Table 7 above, “MANAGEMENT LEVEL 1: UNRECOMMENDED” assumes a case where, even when another object does not satisfy a condition for the permission attribute or the prohibition attribute, the placement of the object is not absolutely prohibited, but is also not recommended. For example, the user is warned that the placement is unrecommended, and then the placement by the user is allowed.

Still additionally, in Table 7 above, “MANAGEMENT LEVEL 2: UNPERMITTED BY CREATOR” means that the prohibition attribute or the permission attribute has been set by the creator of the object. In this case, the creator has an authority to change the setting of the prohibition attribute or the permission attribute. The user (PF operator or player) can also ask the creator who is a person authorized to change the setting to change the setting of the permission attribute or the prohibition attribute.

Yet additionally, in Table 7 above, “MANAGEMENT LEVEL 3: UNPERMITTED BY PF OPERATOR” means that the PF operator who has placed the object in the metaverse has set the prohibition attribute or the permission attribute.

Still additionally, in Table 7 above, “MANAGEMENT LEVEL 4: LEGALLY UNPERMITTED” means that the prohibition attribute or the permission attribute has been set according to legal requirements, and it is assumed that the setting cannot freely be changed by the creator or the PF operator.

In the example shown in Table 6 above, it is possible to set the same management level to a plurality of values or determination expressions but, in another example, such a hierarchical structure as to set the management level to each one of the values or determination expressions may also be used.

As shown in Table 5 above, the determination area according to the present embodiment is set, for each of the objects, as a range when a determination based on the adjacent placement prohibition attribute or permission attribute is to be made, but the present embodiment is not limited thereto. For example, the determination area may also be set for each of the attribute items or may also be set for each one of the prohibition attributes and the permission attributes of the individual attribute items. Alternatively, the same determination area may also be set to the plurality of values or determination expressions illustrated in Table 6 above or the determination area may also be set for each one of the values or determination expressions.

While the specific description has been given heretofore of the configuration of the management organization server 20, the configuration of the management organization server 20 according to the present disclosure is not limited to the example illustrated in FIG. 2. For example, the management organization server 20 need not necessarily have all the configurations illustrated in FIG. 2. Alternatively, the management organization server 20 may also be implemented by a plurality of devices.

### <<1-3. Configuration of Metaverse Server 30>>

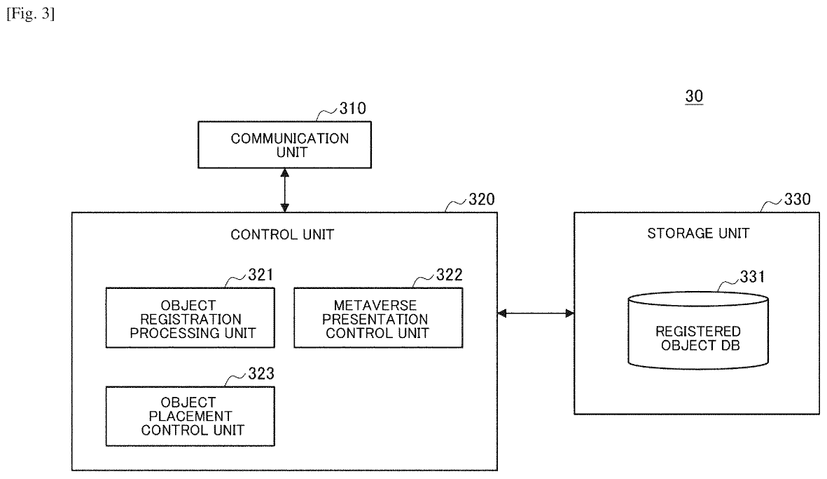

FIG. 3 is a block diagram illustrating an example of a configuration of the metaverse server 30 according to the present embodiment. As illustrated in FIG. 3, the metaverse server 30 includes a communication unit 310, a control unit 320, and a storage unit 330.

### (Communication Unit 310)

The communication unit 310 has a transmitter that transmits data to the external device and a receiver that receives data from the external device. The communication unit 310 according to the present embodiment may also use, e.g., a wired or wireless LAN (Local Area Network), Wi-Fi (registered trademark), Bluetooth (registered trademark), a mobile communication network (LTE (Long Term Evolution), 4G (4th generation mobile communication system), 5G (5th generation mobile communication system)), or the like to be communicatively connected to the external device or the Internet.

### (Control Unit 320)

The control unit 320 functions as each of an arithmetic processing device and a control device, and controls general operation in the metaverse server 30 according to various programs. The control unit 320 is implemented by an electronic circuit such as, e.g., a CPU (Central Processing Unit) or a microprocessor. The control unit 320 may also include a ROM (Read Only Memory) that stores programs, arithmetic parameters, and the like to be used and a RAM (Random Access Memory) that temporarily stores accordingly varying parameters or the like.

The control unit 320 functions also as an object registration processing unit 321, a metaverse presentation control unit 322, and an object placement control unit 323. The object registration processing unit 321 performs processing of registering the object in the metaverse. When the object is brought into the metaverse, the object registration processing unit 321 determines whether or not the object is usable in the metaverse. The object can be brought into the metaverse by. e.g., an operation of uploading main body data (e.g., a 3D model of the object) using the user terminal 10.

When the user (PF operator or player) attempts to bring the object into the metaverse, the object registration processing unit 321 determines whether or not the object is usable in the metaverse on the basis of each of the management information (an example of content management information) to be associated with the object and attribute information (an example of virtual space attribute information) of the metaverse.

The object registration processing unit 321 accesses the management organization server 20 to acquire the management information of the object. When the metaverse ID (see Table 2 above) which is included in the management information and for which the use of the object is permitted is ID (identification information) indicating the metaverse into which the object is intended to be brought, the object registration processing unit 321 determines that the object is usable.

Note that, when the management information does not include the metaverse ID, the object registration processing unit 321 may also refer to the user ID for which the use of the object is permitted and determine that the object is usable when the metaverse into which the object is intended to be brought is the metaverse possessed by the PF operator indicated by the user ID.

Meanwhile, when the management information includes the world view ID indicating the world view in which the use of the object is permitted and when the world view of the metaverse into which the object is intended to be brought is the world view indicated by the world view ID, the object registration processing unit 321 may also determine that the object is usable.

The object registration processing unit 321 stores, in the registered object DB 331, information on the object (e.g., the 3D model of the object) determined to be usable. The object registration processing unit 321 also stores, in the registered object DB 331, the attribute information (see Table 5 above) included in the management information of the object. Note that the attribute information may be embedded in the registered object.

The metaverse presentation control unit 322 performs metaverse presentation control on the user terminal 10. For example, the metaverse presentation control unit 322 performs control of continuously generating a metaverse video on a perspective of the player and transmitting the metaverse video to the user terminal 10. Alternatively, the metaverse presentation control unit 322 may also perform control of transmitting, to the user terminal 10, information required to generate the metaverse video on the perspective of the player.

The object placement control unit 323 controls the placement of the object in the metaverse. More specifically, when the user (PF operator or player) attempts to place, in the metaverse, the object (registered object) determined to be usable in the metaverse by the object registration processing unit 321 and stored in the management information DB 231, the object placement control unit 323 determines whether or not the object is placeable on the basis of each of the attribute information (an example of first content attribute information) of the object and the attribute information (an example of second content attribute information) of the object already placed in the metaverse (hereinafter referred to also as the placed object). Thus, it is possible to inhibit the object from being used in an unpreferable situation against an intention of the creator of the object or the like.

For example, when a placement position at which the object (hereinafter referred to also as a target object) intended to be placed is to be placed is located within the determination area of the placed object already placed in the metaverse, the object placement control unit 323 determines whether or not the target object is placeable on the basis of at least either of the adjacent placement prohibition and permission attributes of the placed object.

By way of example, the object placement control unit 323 determines that the target object is unplaceable when the target object corresponds to the adjacent placement prohibition attribute of the placed object, while determining that the target object is placeable when the target object does not correspond to the adjacent placement prohibition attribute of the placed object. Alternatively, the object placement control unit 323 determines that the target object is unplaceable when the target object does not correspond to the adjacent placement permission attribute of the placed object, while determining that the target object is placeable when the target object corresponds to the adjacent placement permission attribute of the placed object. Still alternatively, the object placement control unit 323 determines that the target object is placeable when the target object does not correspond to the adjacent placement prohibition attribute of the placed object and corresponds to the adjacent placement permission attribute of the placed object.

Meanwhile, when the placed object that is already placed is located within the determination area when the target object is placed at the placement position, the object placement control unit 323 determines whether or not the target object is placeable on the basis of at least either of the adjacent placement prohibition and permission attributes of the target object.

By way of example, the object placement control unit 323 determines that the target object is unplaceable when the placed object corresponds to the adjacent placement prohibition attribute of the target object, while determining that the target object is placeable when the placed object does not correspond to the adjacent placement prohibition attribute of the target object. Alternatively, the object placement control unit 323 determines that the target object is unplaceable when the placed object does not correspond to the adjacent placement permission attribute of the target object, while determining that the target object is placeable when the placed object corresponds to the adjacent placement permission attribute of the target object. Still alternatively, the object placement control unit 323 determines that the target object is placeable when the placed object does not correspond to the adjacent placement prohibition attribute of the target object and corresponds to the adjacent placement permission attribute of the target object.

Yet alternatively, the object placement control unit 323 may also determine that the target object is placeable when the target object satisfies an adjacent placement condition of the placed object (i.e., satisfies at least either of the condition of not corresponding to the adjacent placement prohibition attribute of the placed object and the condition of having the permission attribute) and the placed object satisfies an adjacent placement condition of the target object (i.e., satisfies at least either of the condition of not corresponding to the adjacent placement prohibition attribute of the target object and the condition of having the permission attribute). Thus, it is possible to inhibit either of the target object and the placed object from being used in an unpreferable situation against the intention of the creator of the object.

Note that, as a “case where the object does not correspond to the permission attribute”, a case where a value of the attribute of the object does not match a value of the permission attribute, a case where the determination expression for the permission attribute is not satisfied, or a case where the permission attribute does not have a value corresponding to the defined attribute item is assumed. Meanwhile, as a “case where the object does not correspond to the prohibition attribute”, a case where the value of the attribute of the object does not match a value of the prohibition attribute or a case where the determination expression for the prohibition attribute is not satisfied is assumed.

Additionally, one or more maps can be set in the metaverse. The object placement control unit 323 may also determine whether or not the placed object is placeable on the basis of each of the attribute information of the placed object intended to be placed and the attribute information of the map. As shown in Table 5 above, the determination area may also be set to the map. When the placement position of the placed object is within the determination area of the map, when the placed object satisfies an adjacent placement condition of the map, and when the map satisfies the adjacent placement condition of the placed object, the object placement control unit 323 may also determine that the placed object is placeable. Note that, when the determination area is not set to the map, it is also possible to assume that the entire range of the map is the determination area.

When determining that the target object is unplaceable, the object placement control unit 323 notifies the user of the unplaceability and the reason for the unplaceability (such as the placed object that has led to the unplaceability or the prohibition attribute, the permission attribute, or the like that has led to the unplaceability).

When determining that the target object is unplaceable since the target object does not satisfy the adjacent placement condition of the placed object, the object placement control unit 323 may also notify the user of whether or not an inquiry about a permit application for adjacent placement to a right holder of the placed object (the holder of the authority to change the various settings shown in Table 5 above, such as the creator or PF operator) is necessary. The object placement control unit 323 may also make a notification of whether or not the inquiry about the permit application for the adjacent placement is necessary depending on the management level (see Table 7 above) of the corresponding attribute item. For example, in the case of MANAGEMENT LEVEL: 4, the placement is legally unpermitted, and therefore the object placement control unit 323 does not make a notification of whether or not the inquiry about the permit application for the adjacent placement is necessary. In the case of MANAGEMENT LEVEL: 3, the placement is permitted by the creator, but is unpermitted by the PF operator, and therefore the object placement control unit 323 displays a screen asking the user whether or not to make a permit application for the adjacent placement to the PF operator. In the case of MANAGEMENT LEVEL: 2, the placement is unpermitted by the creator, and therefore the object placement control unit 323 displays a screen asking the user whether or not to make a permit application for the adjacent placement to the creator. In the case of “MANAGEMENT LEVEL: 1”, the object placement control unit 323 warns that the placement is unrecommended, and then displays a screen asking the user whether or not to still perform the placement. Note that, in the case of “MANAGEMENT LEVEL: 0”, it may also be possible that the object placement control unit 323 warns of the unsatisfied adjacent placement condition (e.g., inappropriateness for the world view), and then places the placed object.

When determining that the target object is unplaceable, the object placement control unit 323 may invalidate the operation of placing the target object by the user, may display a warning, or may perform control of turning OFF the display of the target object. The invalidation of the placing operation and the display of the warning may also be simultaneously performed. For example, when the avatar of the player under the age of admission attempts to enter the map provided with an age limit, the object placement control unit 323 inhibits the avatar from moving into the map, while notifying the player that the map has the age limit, and the avatar cannot enter. Alternatively, it may also be possible that the object placement control unit 323 does not draw the target object determined to be unplaceable and notifies the user that the target object is not displayed.

When the object placement control unit 323 determines that the placed object is unplaceable since the placed object does not satisfy the vicinity placement condition of the target object and when the right holder of the target object (the holder of the authority to change the various settings shown in Table 5 above, e.g., the creator or PF operator) is the user himself who performs the placing operation, the object placement control unit 323 displays, together with a warning, a screen asking the user whether or not to still place the target object. As long as the user who performs the placing operation has made non-permission setting, it is desirable that the user can change the setting at his own will.

### (Storage Unit 330)

The storage unit 330 is implemented by a ROM that stores programs, arithmetic parameters, and the like to be used in processing by the control unit 320 and a RAM that temporarily stores accordingly varying parameters or the like.

The storage unit 330 has the registered object DB 331 that stores information related to the registered objects. As an example of the information related to the registered objects, the information (main body data) of the objects themselves determined to be usable in the metaverse, and the attribute information thereof can be listed. The main body data is, e.g., 3D models for drawing the objects. The attribute information may also be information included in the management information acquired from the management organization server 20 at the time of object registration.

While the specific description has been given heretofore of the configuration of the metaverse server 30, the configuration of the metaverse server 30 according to the present disclosure is not limited to the example illustrated in FIG. 3. For example, the metaverse server 30 need not necessarily have all the configurations illustrated in FIG. 3. Alternatively, the metaverse server 30 may also be implemented by a plurality of devices.

### 2. Operation Processing

Next, referring to the drawings, a description will be given of operation processing by the information processing system according to the present embodiment.

### <<2-1. Object Usability Determination Processing>>

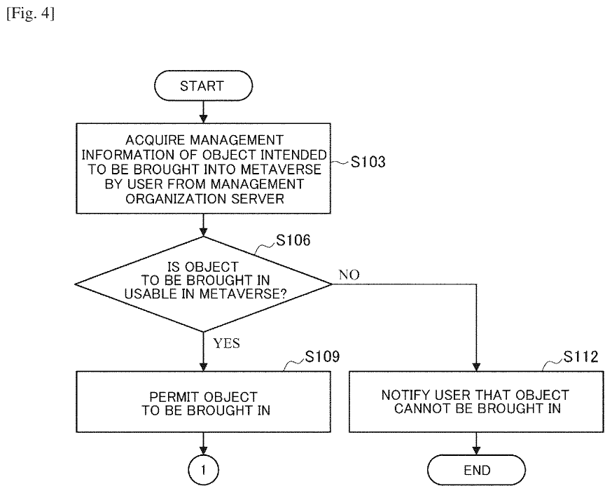

FIG. 4 is a flow chart illustrating an example of a flow of object usability determination processing according to the present embodiment. The usability determination processing illustrated in FIG. 4 can be performed when the user (PF operator or player) brings the object into the metaverse.

As illustrated in FIG. 4, first, the object registration processing unit 321 of the metaverse server 30 acquires, from the management organization server, the management information of the object intended to be brought into the metaverse by the user (Step S103).

Next, the object registration processing unit 321 determines whether or not the object to be brought in is usable in the metaverse on the basis of the management information acquired from the management organization server (Step S106). Specifically, when the metaverse ID (see Table 2 above) which is included in the management information of the object to be brought in and for which the use of the object is permitted is ID (identification information) indicating the metaverse into which the object is intended to be brought in, the object registration processing unit 321 determines that the object is usable.

Then, when determining that the object is usable (Step S106/Yes), the object registration processing unit 321 permits the object to be brought in (Step S109). Specifically, the object registration processing unit 321 stores data on the object in the registered object DB 331 or notifies the user that the registration has been completed.

Meanwhile, when determining that the object is unusable (Step S106/No), the object registration processing unit 321 notifies the user that the object cannot be brought in (Step S112). At this time, the object registration processing unit 321 may also notify the user that the use of the object in the metaverse is not permitted by the creator of the object.

### <<2-2. Object Placeability Determination Processing>>

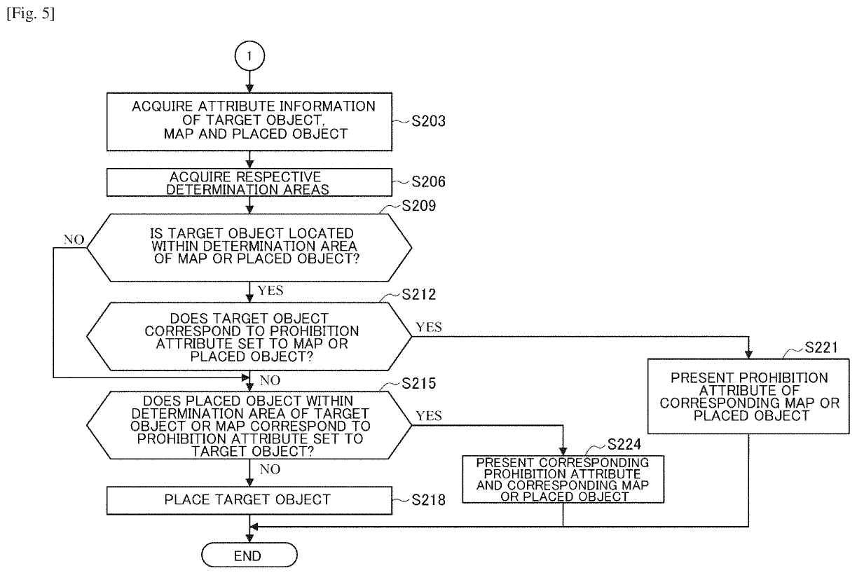

Subsequently, referring to FIG. 5, a description will be given of the placeability determination processing when the object is to be placed in the metaverse. FIG. 5 is a flow chart illustrating an example of a flow of the object placeability determination processing according to the present embodiment. The placeability determination processing illustrated in FIG. 5 can be performed subsequently to Step S109 of the usability determination processing illustrated in FIG. 4. Additionally, in the placeability determination processing illustrated in FIG. 5, by way of example, a description will be given of determination based on the adjacent placement prohibition attribute.

As illustrated in FIG. 5, first, the object placement control unit 323 of the metaverse server 30 acquires, from the registered object DB 331, the target object intended to be placed by the user (who is the PF operator herein), a map of a placement destination, and the attribute information of the one or more placed objects already placed in the map of the placement destination (Step S203).

Next, the object placement control unit 323 acquires respective determination areas of the target object, the map of the placement destination, and the one or more placed objects (Step S206). Information on the determination areas is included in, e.g., the attribute information.

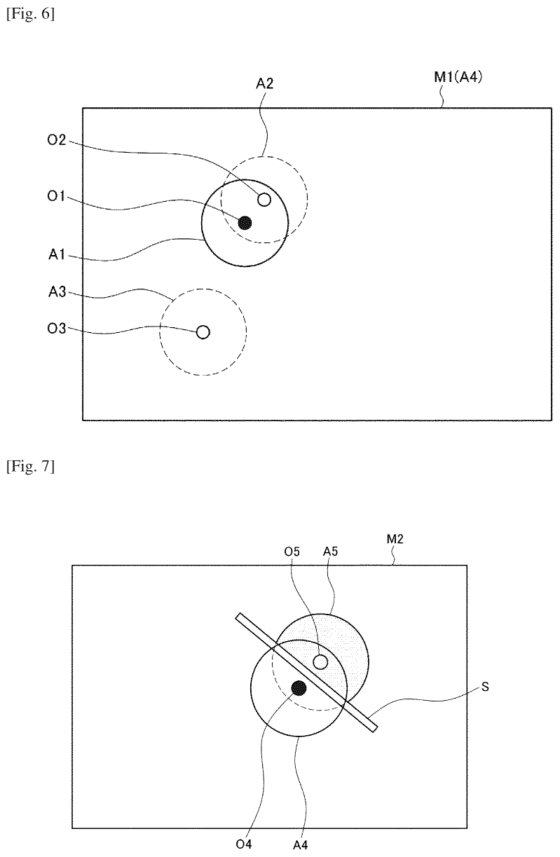

Then, the object placement control unit 323 determines whether or not the target object is located within the determination area of the map or the placed object (Step S209). FIG. 6 is a diagram illustrating an example of the respective determination areas of a target object O1, a map M1, and one or more placed objects O2 and O3. The position of the target object O1 in the map M1 is a position (placement candidate position) at which the target object O1 is intended to be placed in the map M1 by the user (e.g., PF operator). Such a placement candidate position may be specified by, e.g., the PF operator by inputting coordinate information, or may also be intuitively specified by a mouse operation by the PF operator or the like.

In FIG. 6, a determination area A1 of the target object O1, a determination area A4 of the map M1 (the entire range of the map M1), a determination area A2 of the placed object O2, and a determination area A3 of the placed object O3 are illustrated. In this case, the object placement control unit 323 first determines that the target object O1 is located within each of the determination area A4 of the map M1 and the determination area A2 of the placed object O2.

Note that respective sizes of the individual determination areas need not necessarily be the same, and may also be different from each other. Additionally, a shape of each of the determination areas is not limited to a circle as illustrated in FIG. 6, and may be an ellipsoid, a rectangle, or the like or may also be an optional shape different from one of the objects to another. Still additionally, the determination area of the map may be a specified place in the map. Yet additionally, each of the determination areas is not limited to a range in a plane, and may also be a spatial range. In a case where the target object or the placed object moves, an entire region in which the object may possibly move may also be used as the determination area. In the present embodiment, it has been described that the determination areas are included in the attribute information of the object, but the determination areas are not limited thereto, and it may also be possible that a predetermined shape (range) is prepared on the metaverse server 30 side, and the predetermined shape (range) including the object is used as the determination area of the object.

Meanwhile, when there is a shielding object between the target object and the placed object, the object placement control unit 323 may also invalidate area determination through the shielding object. FIG. 7 is a diagram illustrating the area determination when there is the shielding object according to the present embodiment. In the example illustrated in FIG. 7, between the target object O4 intended to be placed in the map M2 and the placed object O5 already placed in the map M2, there is a shielding object S separating the both objects from each other, such as a wall. In this case, the object placement control unit 323 keeps each of the determination areas from affecting a region beyond the shielding object S. Specifically, e.g., the target object O4 is located in the region of the determination area A5 beyond the shielding object S, and therefore the area determination is invalidated, i.e., it is determined that the target object O4 is not located within the determination area A5. Meanwhile, since the placed object O5 is located in the region of the determination area A4 of the target object O4 which is beyond the shielding object S, and therefore the area determination is invalidated, i.e., it is determined that the placed object O5 is not located within the determination area A4.

Next, when the target object is located within the determination area of the map or the placed object (Step S209/Yes), the object placement control unit 323 determines whether or not the target object corresponds to the prohibition attribute set to the map or the placed object (Step S212). In the case of the example illustrated in FIG. 6, the target object O1 is included within each of the determination area A4 of the map M1 and the determination area A2 of the placed object O2, and therefore the object placement control unit 323 checks whether or not the target object O1 corresponds to the prohibition attribute of the map M1 and corresponds to the prohibition attribute of the placed object O2.

Then, when the target object is not located within the determination area of the map or the placed object (Step S209/No) or when the target object does not correspond to the prohibition attribute set to the map or the placed object (Step S212/No), the object placement control unit 323 determines whether or not the placed object located within the determination area of the target object or the map corresponds to the prohibition attribute set to the target object (Step S215).

For example, in the case of the example illustrated in FIG. 6, the placed object O2 is located within the determination area A1 of the target object O1, and therefore the object placement control unit 323 determines whether or not the placed object O2 corresponds to the prohibition attribute set to the target object O1. The object placement control unit 323 further determines whether or not the map M1 corresponds to the prohibition attribute set to the target object O1.

Then, when the placed object located within the determination area of the target object or the map does not correspond to the prohibition attribute set to the target object (Step S215/No), the object placement control unit 323 determines that the target object is placeable, i.e., places the target object (Step S218).

Meanwhile, when it is determined in Step S212 described above that the target object corresponds to the prohibition attribute set to the map or the placed object (Step S212/Yes), the object placement control unit 323 presents, to the user, the prohibition attribute of the corresponding map or placed object (Step S221). Thus, it becomes possible to allow the user to recognize what factor has led to the unplaceability determination. The user can take measures such as placing the target object again at a position away from the corresponding placed object. When the map itself is the factor, it is possible to take measures such as stopping the placement in the map and placing the target object again in another map. The user can take measures such as changing of the object to be placed according to the corresponding prohibition attribute.

When it is determined in Step S215 described above that the placed object located within the determination area of the target object or the map corresponds to the prohibition attribute set to the target object (Step S215/Yes), the object placement control unit 323 presents, to the user, the corresponding prohibition attribute (of the target object) and the corresponding map or placed object (S224). Thus, it is possible to allow the user to recognize what factor has led to the unplaceability determination.

While the specific description has been given heretofore of the placeability determination processing according to the present embodiment, the present embodiment is not limited to the example illustrated in FIG. 5. In FIG. 5, by way of example, the determination based on the adjacent placement prohibition attribute has been described, but the determination may also be made by further considering the permission attribute.

When determining that the target object is unplaceable on the basis of the adjacent placement permission attribute of the placed object, the object placement control unit 323 may also display a permission attribute required to perform the placement. Note that the prohibition attribute and the permission attribute are not necessarily set for all the attribute items of each of the objects and the map and, when at least either of the prohibition attribute and the permission attribute is set, whether or not the adjacent placement is possible can be determined as appropriate.

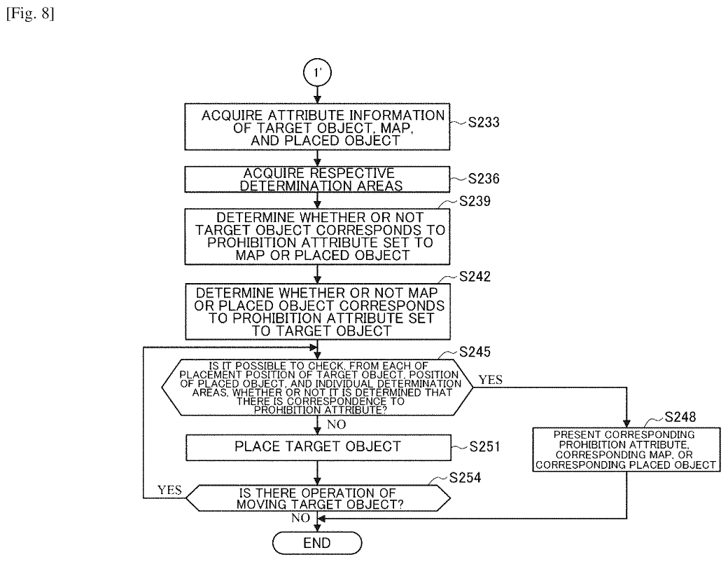

While the example illustrated in FIG. 5 mainly assumes the placeability determination processing when the PF operator places the object in the metaverse, the placeability determination processing described above can similarly be performed even when the player participating in the metaverse prepared by the PF operator operates his own avatar and moves in the metaverse. Note that, in the case of placement of the avatar by the player, it is assumed that the placement position frequently changes (due to the movement of the avatar) and therefore, by determining whether or not the avatar can be placed adjacent to the map or each of the objects before the movement of the avatar, it is possible to omit the determination processing for each movement. Referring to FIG. 8, a specific description will be given below.

<<2-3. Object Placeability Determination Processing-Placement by Player>>FIG. 8 is a flow chart illustrating another example of the flow of the object placeability determination processing according to the present embodiment.

As illustrated in FIG. 8, first, the object placement control unit 323 of the metaverse server 30 acquires, from the registered object DB 331, the attribute information of the target object (e.g., the avatar of the player) intended to be placed by the user (who is the player herein), the map of the placement destination, and the one or more placed objects already placed in the map of the placement destination (Step S233).

Then, the object placement control unit 323 acquires the respective determination areas of the target object, the map of the placement destination, and the one or more placed objects (Step S236).

Then, the object placement control unit 323 determines whether or not the target object corresponds to the prohibition attribute set to the map or the placed object (Step S239). The object placement control unit 323 determines whether or not the target object corresponds to the prohibition attribute set to the map or each of all the placed objects placed in the map (at least each of the placed objects placed within a range in which the avatar of the user can move) irrespective of the determination area.

Next, the object placement control unit 323 determines whether or not the placed object or the map corresponds to the prohibition attribute set to the target object (Step S242). The object placement control unit 323 determines whether or not the map or each of all the placed objects placed in the map (at least each of the placed objects placed within the range in which the avatar of the user can move) corresponds to the prohibition attribute set to the target object irrespective of the determination area of the target object.

Thus, in the present embodiment, prior to an operation of moving the avatar (target object) by the player, placeability determination is made between the avatar and all the placed objects.

Then, the object placement control unit 323 checks, from each of the placement position at which the target object (avatar) is intended to be placed by the user (player) (move destination of the avatar), the position of the placed object, and the individual determination areas (determination areas of the target object, the map, and the placed objects), whether or not it is determined that there is the correspondence to the prohibition attribute (Step S245). In the present embodiment, in Steps S239 to S242 described above, it is already determined whether or not there is the correspondence to the prohibition attribute. Therefore, the object placement control unit 323 checks whether or not it is determined that the avatar corresponds to the prohibition attribute of the map or the placed object having the determination area including a position (placement position) to which the avatar is intended to be moved by the player or whether or not it is determined that the map or the placed object located in the determination area of the avatar corresponds to the prohibition attribute of the avatar.

Next, when it is not determined that there is the correspondence to the prohibition attribute (Step S245/No), the object placement control unit 323 determines that the target object is placeable, i.e., places the object (Step S251).

Then, every time the user performs the operation of moving the target object (Step S254/Yes), the object placement control unit 323 performs the processing shown in Step S245 described above.

When it is determined in S245 described above that there is the correspondence to the prohibition attribute (Step S245/Yes), the object placement control unit 323 presents the corresponding prohibition attribute, the corresponding map, or the corresponding placed object (Step S248).

While the specific description has been given heretofore of the case of the placement by the player as the other example of the placeability determination processing according to the present embodiment, the present embodiment is not limited to the example illustrated in FIG. 8. In FIG. 8, by way of example, the determination based on the adjacent placement prohibition attribute has been described, but the determination may also be made by further considering the permission attribute. In Step S248 described above, the object placement control unit 323 may also invalidate the moving operation by the user and present at least the prohibition attribute and the required permission attribute.

### 3. Supplement

While the detailed description has been given heretofore of the preferred embodiments of the present disclosure with reference to the accompanying drawings, the present technology is not limited to such examples. It is clear that a person having ordinary knowledge in the technical field of the present disclosure can conceive of various modified examples or amended examples within the scope of the technical idea described in the claims, and it should be understood that these also belong to the technical scope of the present disclosure.

For example, in the embodiment described above, as an example of the content, an object such as a character, an avatar, an item, a building, or a map is listed, but the present disclosure is not limited thereto. As another example of the content, e.g., an image, a video, a sound, or the like can be listed.

With regard to drawings of the object, depending on the creator, a demand to allow the drawing only in a specified direction is also assumed. Accordingly, it may also be possible to cause drawing direction specification information to be included in the attribute information of the object and, when generating a metaverse video or the like, the metaverse presentation control unit 322 draws the object on the basis of the drawing direction specification information. Alternatively, it may also be possible to cause placement direction specification information to be included in the attribute information of the object and, when placing the target object, the object placement control unit 323 constrains the placement of the object on the basis of the placement direction specification information.

It is also possible to produce one or more computer programs for causing hardware such as the CPU, the ROM, or the RAM embedded in the management organization server 20 or the metaverse server 30 described above to perform the function of the management organization server 20 or the metaverse server 30. Moreover, a computer readable storage medium storing thereon the one or more computer programs is also provided.

In addition, the effects described in the present description are merely descriptive or illustrative, and are not limitative. In other words, the technology according to the present disclosure can achieve, along with or instead of the above effects, other effects apparent to a person skilled in the art from the statement of the present description.

Note that the present technology can also be embodied in the following configurations.

(1)
An information processing apparatus including
circuitry configured to
determine, based on virtual space attribute information associated with a virtual space of a plurality of different virtual spaces and first content management information associated with first content, whether or not the first content is permitted to be used in the virtual space, and
control placement, when the first content is permitted to be used in the virtual space, of the first content in the virtual space based on first content attribute information of the first content and second content attribute information associated with second content already placed in the virtual space.
   (2)

The information processing apparatus according to (1) above, wherein,
when the first content corresponds to an adjacent placement prohibition attribute included in the second content attribute information, or
when the second content corresponds to an adjacent placement prohibition attribute
included in the first content attribute information, the circuitry determines that the first content is not permitted to be placed adjacent to the second content, and
wherein,
when the first content does not correspond to the adjacent placement prohibition attribute included in the second content attribute information, and
when the second content does not correspond to the adjacent placement prohibition attribute included in the first content attribute information,
the circuitry determines that the first content is permitted to be placed adjacent to the second content.
   (3)

The information processing apparatus according to (1) or (2) above, wherein,
when the first content corresponds to an adjacent placement permission attribute included in the second content attribute information, and
when the second content corresponds to an adjacent placement permission attribute included in the first content attribute information,
the circuitry determines that the first content is permitted to be placed adjacent to the second content, and
wherein
when the first content does not correspond to the adjacent placement permission attribute included in the second content attribute information, or
when the second content does not correspond to the adjacent placement permission attribute included in the first content attribute information,
the circuitry determines that the first content is not permitted to be placed adjacent to the second content.
   (4)

The information processing apparatus according to any one of (1) to (3) above, wherein,
when the first content does not correspond to an adjacent placement prohibition attribute included in the second content attribute information and the first content corresponds to an adjacent placement permission attribute included in the second content attribute information, the circuitry determines that the first content is permitted to be placed adjacent to the second content.
   (5)

The information processing apparatus according to any one of (1) to (4) above, wherein,
wherein, when a position at which the first content is scheduled to be placed is included within a range indicated by an adjacent placement determination area included in the second content attribute information, the circuitry determines whether or not the first content is permitted to be placed adjacent to the second content.
   (6)

The information processing apparatus according to any one of (1) to (5) above, wherein,
when determining that the first content is not permitted to be placed adjacent to the second content in the virtual space, the circuitry is further configured to notify a user who performs an operation of placing the first content of whether or not an inquiry about a permit application to a right holder of the second content is necessary.
   (7)

The information processing apparatus according to any one of (1) to (6) above, wherein,
when a position at which the first content is scheduled to be placed is included within a range indicated by an adjacent placement determination area included in the second content attribute information, and
when a shielding object separates the first content from the second content, the circuitry determines that the first content is permitted to be placed within the indicated range regardless of adjacent permission attributes or prohibition attributes included in the first content attribute information and the second content attribute information.
   (8)

The information processing apparatus according to any one of (1) to (7) above, wherein,
when the circuitry determines that the first content is not permitted to be used in the virtual space based on correspondence to a prohibition attribute, the circuitry is further configured to notify a user who performs an operation of placing the first content of the correspondence to the prohibition attribute.
   (9)

The information processing apparatus according to any one of (1) to (8) above, wherein,
when the second content does not correspond to an adjacent placement prohibition attribute included in the first content attribute information and the second content corresponds to an adjacent placement permission attribute included in the first content attribute information, the circuitry determines that the first content is permitted to be placed adjacent to the second content.
   (10)

The information processing apparatus according to any one of (1) to (9) above, wherein,
when the second content is located within a range indicated by an adjacent placement determination area included in the first content attribute information, the circuitry determines whether or not the first content is permitted to be placed within the indicated range.
   (11)

The information processing apparatus according to any one of (1) to (10) above, wherein,
when the circuitry determines that the first content is not permitted to be placed in the virtual space and when a right holder of the first content is a user who performs an operation of placing the first content, the circuitry is further configured to initiate display, together with a warning, of a screen asking the user whether or not to place the first content.
   (12)

The information processing apparatus according to any one of (1) to (11) above, wherein, when determining that the first content is not permitted to be placed in the virtual space, the circuitry is further configured to notify a user who performs an operation of placing the first content of at least one of a corresponding prohibition attribute or a required permission attribute and the second content that has caused the determination that the first content is not permitted to be placed in the virtual space.

(13)

The information processing apparatus according to any one of (1) to (12) above, wherein the first content attribute information is included in the first content management information.

(14)

The information processing apparatus according to any one of (1) to (13) above, wherein the circuitry determines whether or not the first content is usable in the virtual space based on information related to each virtual space where use of the first content is permitted, which is included in the first content management information, and the virtual space attribute information.

(15)

The information processing apparatus according to any one of (1) to (14) above, wherein the information related to the virtual space where the use of the first content is permitted is virtual space identification information or world view information.

(16)

The information processing apparatus according to any one of (1) to (15) above, wherein,
when determining that the first content is not permitted to be used in the virtual space, the circuitry is further configured to notify a user who performs an operation of bringing in the first content that the first content is not permitted to be brought into the virtual space.
   (17)

The information processing apparatus according to any one of (1) to (16) above, wherein
the first content or the second content includes at least one of an avatar, a character, or an item, and
wherein the first content attribute information or the second content attribute information includes information on each attribute item including at least one of a content size, a weight, a world view, an age, a gender, a race, a classification, or an occupation, and information on an adjacent placement prohibition attribute or permission attribute in each attribute item.
   (18)

The information processing apparatus according to any one of (1) to (17) above, wherein the circuitry controls placement of the first content in a map based on each of the first content attribute information of the first content and attribute information associated with the map to be set in the virtual space.

(19)

An information processing method including
determining, based on virtual space attribute information associated with a virtual space of a plurality of different virtual spaces and first content management information associated with first content, whether or not the first content is permitted to be used in the virtual space, and
controlling placement, when the first content is permitted to be used in the virtual space, of the first content in the virtual space based on first content attribute information of the first content and second content attribute information associated with second content already placed in the virtual space.
   (20)

A non-transitory computer-readable storage medium having embodied thereon a program, which when executed by a computer causes the computer to execute a method, the method including
determining, based on virtual space attribute information associated with a virtual space of a plurality of different virtual spaces and first content management information associated with first content, whether or not the first content is permitted to be used in the virtual space, and
controlling placement, when the first content is permitted to be used in the virtual space, of the first content in the virtual space based on first content attribute information of the first content and second content attribute information associated with second content already placed in the virtual space.

### REFERENCE SIGNS LIST

1 Information processing system
10 User terminal
20 Management organization server
210 Communication unit
220 Control unit
221 Object Management Unit
230 Storage unit
231 Management information DB
30 Metaverse server
310 Communication unit
320 Control unit
321 Object registration processing unit
322 Metaverse presentation control unit
323 Object placement control unit
330 Storage unit
331 Registered object DB
40 Network

1. An information processing apparatus comprising:
circuitry configured to
determine, based on virtual space attribute information associated with a virtual space of a plurality of different virtual spaces and first content management information associated with first content, whether or not the first content is permitted to be used in the virtual space, and control placement, when the first content is permitted to be used in the virtual space, of the first content in the virtual space based on first content attribute information of the first content and second content attribute information associated with second content already placed in the virtual space.

2. The information processing apparatus according to claim 1,
wherein,
when the first content corresponds to an adjacent placement prohibition attribute included in the second content attribute information, or
when the second content corresponds to an adjacent placement prohibition attribute included in the first content attribute information, the circuitry determines that the first content is not permitted to be placed adjacent to the second content, and
wherein,
when the first content does not correspond to the adjacent placement prohibition attribute included in the second content attribute information, and
when the second content does not correspond to the adjacent placement prohibition attribute included in the first content attribute information, the circuitry determines that the first content is permitted to be placed adjacent to the second content.

3. The information processing apparatus according to claim 1,
wherein,
when the first content corresponds to an adjacent placement permission attribute included in the second content attribute information, and
when the second content corresponds to an adjacent placement permission attribute included in the first content attribute information, the circuitry determines that the first content is permitted to be placed adjacent to the second content, and
wherein
when the first content does not correspond to the adjacent placement permission attribute included in the second content attribute information, or
when the second content does not correspond to the adjacent placement permission attribute included in the first content attribute information, the circuitry determines that the first content is not permitted to be placed adjacent to the second content.

4. The information processing apparatus according to claim 1,
wherein, when the first content does not correspond to an adjacent placement prohibition attribute included in the second content attribute information and the first content corresponds to an adjacent placement permission attribute included in the second content attribute information, the circuitry determines that the first content is permitted to be placed adjacent to the second content.

5. The information processing apparatus according to claim 2,
wherein, when a position at which the first content is scheduled to be placed is included within a range indicated by an adjacent placement determination area included in the second content attribute information, the circuitry determines whether or not the first content is permitted to be placed adjacent to the second content.

6. The information processing apparatus according to claim 2,
wherein, when determining that the first content is not permitted to be placed adjacent to the second content in the virtual space, the circuitry is further configured to notify a user who performs an operation of placing the first content of whether or not an inquiry about a permit application to a right holder of the second content is necessary.

7. The information processing apparatus according to claim 1,
wherein,
when a position at which the first content is scheduled to be placed is included within a range indicated by an adjacent placement determination area included in the second content attribute information, and
when a shielding object separates the first content from the second content,
the circuitry determines that the first content is permitted to be placed within the indicated range regardless of adjacent permission attributes or prohibition attributes included in the first content attribute information and the second content attribute information.

8. The information processing apparatus according to claim 1,
wherein, when the circuitry determines that the first content is not permitted to be used in the virtual space based on correspondence to a prohibition attribute, the circuitry is further configured to notify a user who performs an operation of placing the first content of the correspondence to the prohibition attribute.

9. The information processing apparatus according to claim 1,
wherein, when the second content does not correspond to an adjacent placement prohibition attribute included in the first content attribute information and the second content corresponds to an adjacent placement permission attribute included in the first content attribute information, the circuitry determines that the first content is permitted to be placed adjacent to the second content.

10. The information processing apparatus according to claim 2,
wherein, when the second content is located within a range indicated by an adjacent placement determination area included in the first content attribute information, the circuitry determines whether or not the first content is permitted to be placed within the indicated range.

11. The information processing apparatus according to claim 2,
wherein, when the circuitry determines that the first content is not permitted to be placed in the virtual space and when a right holder of the first content is a user who performs an operation of placing the first content, the circuitry is further configured to initiate display, together with a warning, of a screen asking the user whether or not to place the first content.

12. The information processing apparatus according to claim 1,
wherein, when determining that the first content is not permitted to be placed in the virtual space, the circuitry is further configured to notify a user who performs an operation of placing the first content of at least one of a corresponding prohibition attribute or a required permission attribute and the second content that has caused the determination that the first content is not permitted to be placed in the virtual space.

13. The information processing apparatus according to claim 1,
wherein the first content attribute information is included in the first content management information.

14. The information processing apparatus according to claim 1,
wherein the circuitry determines whether or not the first content is usable in the virtual space based on information related to each virtual space where use of the first content is permitted, which is included in the first content management information, and
the virtual space attribute information.

15. The information processing apparatus according to claim 14,
wherein the information related to the virtual space where the use of the first content is permitted is virtual space identification information or world view information.

16. The information processing apparatus according to claim 1,
wherein, when determining that the first content is not permitted to be used in the virtual space, the circuitry is further configured to notify a user who performs an operation of bringing in the first content that the first content is not permitted to be brought into the virtual space.

17. The information processing apparatus according to claim 1,
wherein the first content or the second content includes at least one of an avatar, a character, or an item, and
wherein the first content attribute information or the second content attribute information includes
information on each attribute item including at least one of a content size, a weight, a world view, an age, a gender, a race, a classification, or an occupation, and
information on an adjacent placement prohibition attribute or permission attribute in each attribute item.

18. The information processing apparatus according to claim 1,
wherein the circuitry controls placement of the first content in a map based on each of the first content attribute information of the first content and attribute information associated with the map to be set in the virtual space.

19. An information processing method, implemented via at least one processor, the method comprising:
determining, based on virtual space attribute information associated with a virtual space of a plurality of different virtual spaces and first content management information associated with first content, whether or not the first content is permitted to be used in the virtual space; and
controlling placement, when the first content is permitted to be used in the virtual space, of the first content in the virtual space based on first content attribute information of the first content and second content attribute information associated with second content already placed in the virtual space.

20. A non-transitory computer-readable storage medium having embodied thereon a program, which when executed by a computer causes the computer to execute a method, the method comprising:
determining, based on virtual space attribute information associated with a virtual space of a plurality of different virtual spaces and first content management information associated with first content, whether or not the first content is permitted to be used in the virtual space; and
controlling placement, when the first content is permitted to be used in the virtual space, of the first content in the virtual space based on first content attribute information of the first content and second content attribute information associated with second content already placed in the virtual space.
